(19) United States
(12) Patent Application Publication
(10) Pub. No.: US 2012/0080244 A1
(43) Pub. Date: Apr. 5, 2012

(54) ELECTRIC-POWERED SCOOTER WITH INDEPENDENT GROUND ENGAGING MECHANISMS

(76) Inventor: Jen-En HOU, Chiayi County (TW)

(21) Appl. No.: 13/250,722

(22) Filed: Sep. 30, 2011

(30) Foreign Application Priority Data
Sep. 30, 2010 (CN) 201020550430.8

(51) Int. Cl. B62D 61/10

(52) U.S. Cl. 180/24.07; 180/22

(57) ABSTRACT

An electric-powered scooter with independent ground engaging mechanisms is equipped with two powered wheels pivoted on a pair of rotatable racks respectively, and each of the rotatable rack is pivoted to a first shaft protruded from the vehicle frame of the electric-powered scooter. When one of the ground engaging wheels is bumped against an obstacle and bouncing upward would cause the rotatable racks to rotate and lowering the respective powered wheels immediately, by this way to enhance the traction of powered wheels over uneven terrain.

### BACKGROUND OF THE INVENTION

1. Field of the Invention

The present invention relates generally to an electric-powered scooter, especially to an electric-powered scooter equipped with two independent ground engaging mechanisms that can lower the powered wheel when the electric-powered scooter bumped against an obstacle.

2. Description of the Related Art

For enhancing the driving safety on uneven terrain, some of the traditional electric-powered scooters have equipped with ground engaging wheels. However, when bumping against an obstacle during a driving, the powered wheel may be lifted by the ground engaging wheels and then lost or decrease the traction thereof, this would cause the scooter waste of energy or may not move anymore.

### SUMMARY OF THE INVENTION

To solve the mentioned problem, the present invention provides an electric-powered scooter with independent ground engaging mechanisms comprises at least a vehicle frame, a battery, a pair of rear wheels, a pair of rotatable racks, a pair of powered wheels, a pair of suspension arms and a pair of shock absorbing elements. Each of the powered wheels is pivoted on the pair of rotatable racks, and each of the pair of rotatable racks is pivoted to a first shaft protruded from the vehicle frame. The pair of suspension arms each has one end pivoted to a second shaft protruded from the vehicle frame and another end equipped with a ground engaging wheel. The pair of shock absorbing elements are associated between the suspension arms and the rotatable racks respectively. When one of the ground engaging wheels is bumped against an obstacle and bouncing upward would cause the rotatable racks to rotate and lowering the respective powered wheel immediately, so as to enhance the traction of powered wheels over uneven terrain.

### BRIEF DESCRIPTION OF THE DRAWINGS

The accompanying drawings, which are included to provide a further understanding of the invention are incorporated in and constitute a part of this specification, illustrate embodiments of the invention and together with the description serve to explain the principles of the invention. In the drawings:

FIG. 1 is a perspective view showing an electric-powered scooter with independent ground engaging mechanisms according to the present invention.

FIG. 2 is a partially exploded perspective view of the electric-powered scooter.

FIG. 3 is a side view showing the relation of the pivot portions and the shafts of the electric-powered scooter.

FIG. 4 is a side view showing the force arms by which may yield the necessary torques to move one of the powered wheels downward when one of the ground engaging wheels is lifted by an uneven ground.

FIG. 5 is a side view schematically showing one of the ground engaging wheels of the electric-powered scooter has lifted by the uneven ground suddenly, and the powered wheel is lowering by the independent ground engaging mechanisms according to the present invention for keeping its traction in the meantime.

FIG. 6 is a side view schematically showing the ground engaging wheels may always kept a force to engage with the ground in normal driving.

### DETAILED DESCRIPTION OF THE PREFERRED EMBODIMENTS

Reference will now be made in detail to the preferred embodiments of the present invention; examples of which are illustrated in the accompanying drawings.

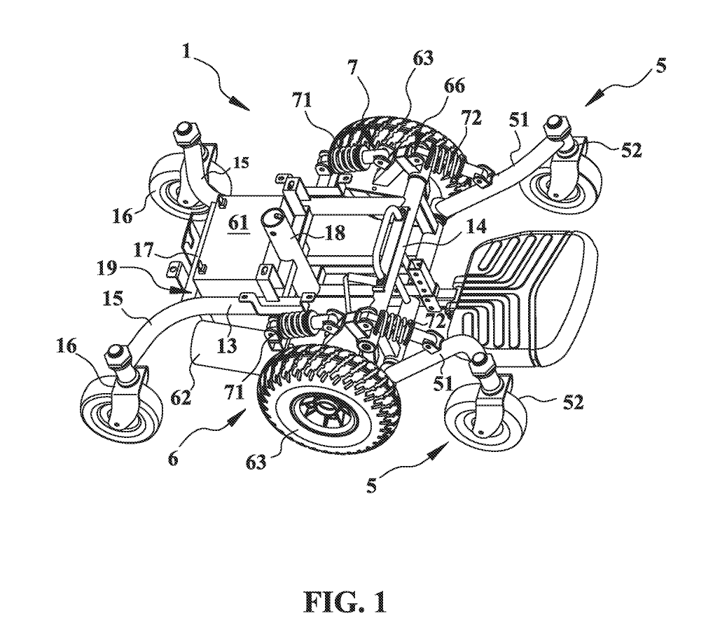

Referring to FIGS. 1 to 4, a preferred embodiment of the electric-powered scooter with independent ground engaging mechanisms, comprises at least a vehicle frame 1, a battery 61, a pair of rear wheels 16, a pair of rotatable racks 66, a pair of powered wheels 63, a pair of suspension arms 51 for coupling with the ground engaging wheel set 5 and a pair of shock absorbing elements 7 for associating the driving system 6 of the powered wheels 63 and the pair of suspension arms 51.

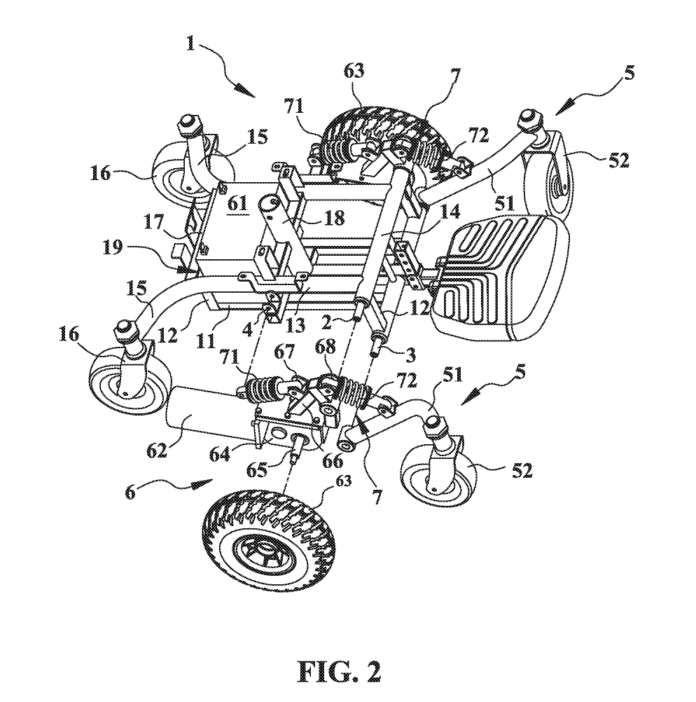

Referring to FIG. 2, each of the powered wheels 63 is pivoted on the pair of rotatable racks 66, and each of the pair of rotatable racks 66 is pivoted to a first shaft 2 protruded from the vehicle frame 1. The powered wheels 63 are driven by two motors 62 connected to the rotatable racks 66 respectively and independently. Preferably, each of the motor 62 may be equipped with a speed reducer 64 for lowing the speed for enlarging the torque thereof to drive the shaft 65 of the powered wheels 63

The vehicle frame 1 has a rear end and two sides each equipped with a first shaft 2 and a second shaft 3 spaced apart from the first shaft 2. In one embodiment, the vehicle frame 1 may comprise a base frame 11 connected with a plurality of posts 12, a pair of side support members 13 connected with the plurality of posts 12, and a front transverse brace 14 and a rear transverse brace 17 connected between the side support members 13 thereby forming a receiving space 19 therebetween. The battery 61 is retractably received within the receiving space 19 for supplying electric power to the electric-powered scooter.

Preferably, the vehicle frame 1 may further comprise a seat post 18 for detachably mounting a seat thereupon. Further, each of the side support members 13 may have a flange on the middle portion thereof for use as a pivot portion 4 thereby pivoting with one of the shock absorbing elements 7.

The pair of rear wheels 16 may be connected to the rear end of the vehicle frame 1. Preferably, the side support members 13 each may have a rear extension arm 15 for connecting with one of the rear wheels 16.

The pair of suspension arms 51 each has one end pivoted to a second shaft 3 protruded from the vehicle frame 1 and another end equipped with a ground engaging wheel 52.

The pair of shock absorbing elements 7 each is associated between one of the suspension arms 51 and the rotatable racks 66 respectively. The pair of shock absorbing elements 7 may be made of resilient material, or a spring-loaded retractable bar, or a pneumatic bar, for absorbing the impact force from the uneven ground through the transmission of ground engaging wheels 52.

The shock absorbing elements 7 each may include a second shock absorbing element 72 for interconnecting between the rotatable rack 66 and the suspension arm 51. According to the embodiment of the present invention, the shock absorbing elements 7 may further include a first shock absorbing element 71 for interconnecting between the rotatable rack 66 and the side support members 13.

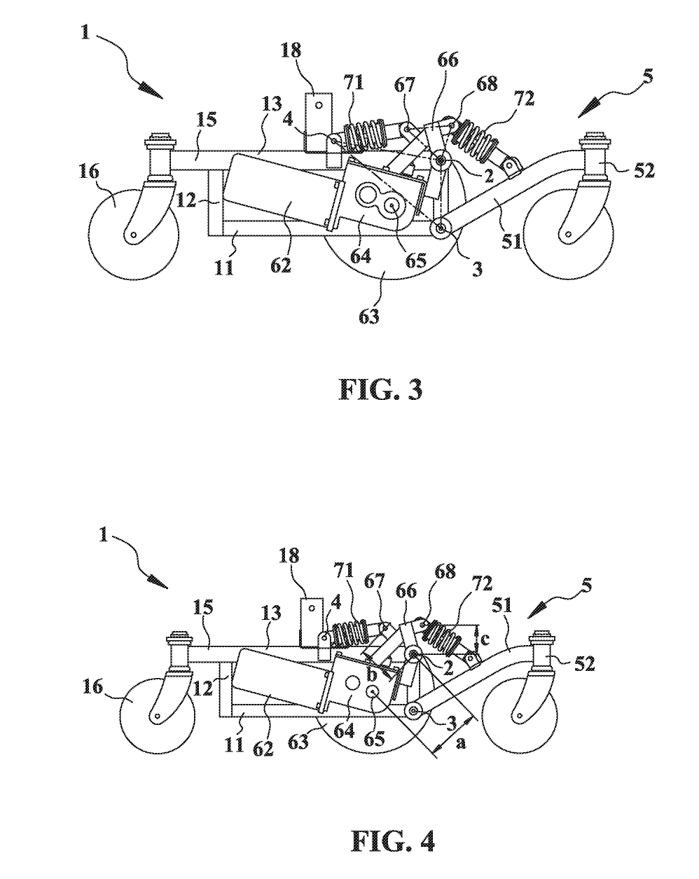

Referring to FIGS. 3 and 4, the pair of rotatable racks 66 each may comprise a first pivot portion 67 for pivoting with the first shock absorbing element 71 and a second pivot portion 68 spaced apart from the first pivot portion 67 for pivoting with the second shock absorbing element 72.

The force arms which denoted as a, b and c in FIG. 4, may yield the necessary torques to move one of the powered wheels 63 downward when one of the ground engaging wheels 52 is bouncing up by uneven ground.

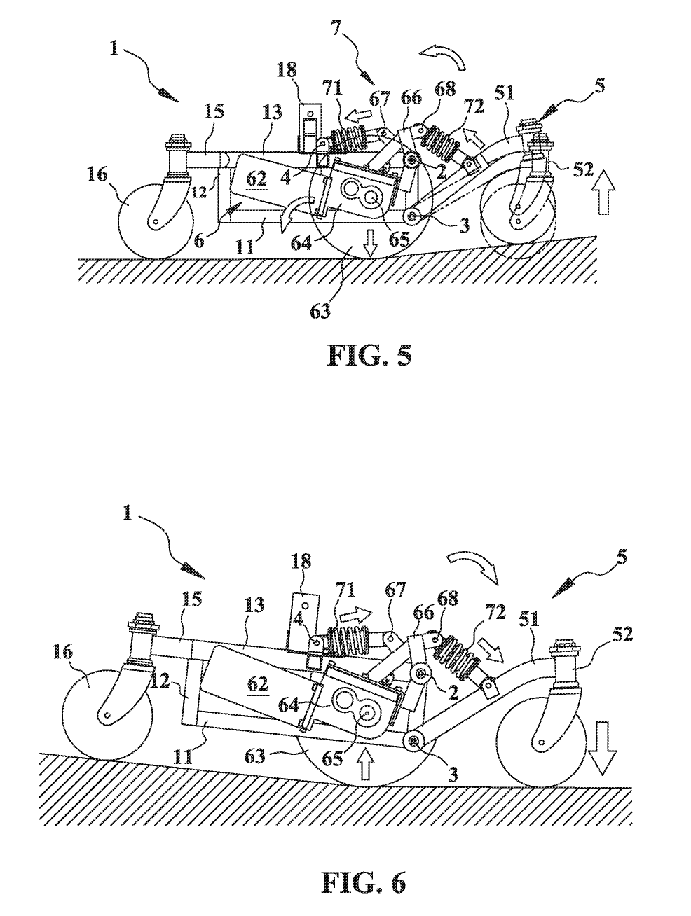

Referring to FIG. 5, when one of the ground engaging wheels 52 is bumped against an obstacle and bouncing upward would cause the rotatable racks 66 to rotate and lowering the respective powered wheels 63 immediately, so as to enhance the traction of powered wheels 63 over the uneven terrain. Referring to FIG. 6, the ground engaging wheels 52 may always be biased by a torque to engage with the ground in normal driving.

While particular embodiments of the invention have been described, those skilled in the art will recognize that many modifications are possible that will achieve the same goals by substantially the same system, device or method, and where those systems, devices or methods still fall within the true spirit and scope of the invention disclosed.

What is claimed is:

1. An electric-powered scooter with independent ground engaging mechanisms, comprising at least:
a vehicle frame, having a rear end and two sides each equipped with a first shaft and a second shaft spaced apart from the first shaft;
a battery, detachably connected to the vehicle frame for supplying electric power to the electric-powered scooter;
a pair of rear wheels, connected to the rear end of the vehicle frame;
a pair of rotatable racks; pivoted to the first shaft respectively on the sides of the vehicle frame;
a pair of powered wheels, pivoted on the pair of rotatable racks respectively;
a pair of suspension arms, each having one end pivoted to the second shaft, and another end equipped with a ground engaging wheel; and
a pair of shock absorbing elements, associated between the suspension arms and the rotatable racks respectively.

2. The electric-powered scooter with independent ground engaging mechanisms of claim 1, wherein the pair of shock absorbing elements each comprises a first shock absorbing element associated between the vehicle frame and the rotatable racks.

3. The electric-powered scooter with independent ground engaging mechanisms of claim 1, wherein the pair of shock absorbing elements each comprises a second shock absorbing element associated between the suspension arms and the rotatable racks.

4. The electric-powered scooter with independent ground engaging mechanisms of claim 1, wherein the pair of shock absorbing elements includes a spring-loaded retractable bar.

5. The electric-powered scooter with independent ground engaging mechanisms of claim 1, wherein the pair of shock absorbing elements includes a pneumatic bar.

6. The electric-powered scooter with independent ground engaging mechanisms of claim 1, wherein the shock absorbing element includes a first shock absorbing element and a second shock absorbing element, and the pair of rotatable racks each comprises a first pivot portion for pivoting with the first shock absorbing element and a second pivot portion spaced apart from the first pivot portion for pivoting with the second shock absorbing element.

7. The electric-powered scooter with independent ground engaging mechanisms of claim 1 further includes two motors connected to the rotatable racks respectively for driving the powered wheels independently.

8. The electric-powered scooter with independent ground engaging mechanisms of claim 7, wherein each of the motor is equipped with a speed reducer for lowing the speed thereof to drive a shaft of the powered wheels.

9. The electric-powered scooter with independent ground engaging mechanisms of claim 1, wherein the vehicle frame comprises a base frame connected with a plurality of posts, a pair of side support members connected with the plurality of posts, and a front transverse brace and a rear transverse brace connected between the side support members thereby forming a receiving space therebetween.

10. The electric-powered scooter with independent ground engaging mechanisms of claim 9 wherein the side support members each has a pivot portion for pivoting with one of the shock absorbing elements.

11. The electric-powered scooter with independent ground engaging mechanisms of claim 10 wherein the shock absorbing elements each has one end pivoted to the side support members, and another end pivoted to the rotatable racks.

12. The electric-powered scooter with independent ground engaging mechanisms of claim 9 wherein the side support members each has a rear extension arm connected with one of the rear wheels.

13. The electric-powered scooter with independent ground engaging mechanisms of claim 9 wherein the vehicle frame comprises a seat post for detachably supporting a seat thereupon.

14. The electric-powered scooter with independent ground engaging mechanisms of claim 9, wherein the pair of shock absorbing elements includes a spring-loaded retractable bar.

15. The electric-powered scooter with independent ground engaging mechanisms of claim 9, wherein the pair of shock absorbing elements includes a pneumatic bar.
